(19) United States
(12) Patent Application Publication
(10) Pub. No.: US 2025/0077038 A1
(43) Pub. Date: Mar. 6, 2025

(54) INFORMATION PROCESSING DEVICE AND DISPLAY CONTROL METHOD

(71) Applicant: Faurecia Clarion Electronics Co., Ltd., Saitama-shi (JP)

(72) Inventors: Kazuya NINOMIYA, Saitama (JP); Haruki ONO, Saitama (JP); Taishin KONISHI, Saitama (JP)

(21) Appl. No.: 18/824,555

(22) Filed: Sep. 4, 2024

(30) Foreign Application Priority Data
Sep. 6, 2023 (JP) 2023-144754

(51) Int. Cl. G06F 3/0481; G06F 3/04845

(52) U.S. Cl. CPC G06F 3/0481; G06F 3/04845; G06F 2203/04803

(57) ABSTRACT

An information processing device connected to a display device and a pointing device simultaneously starts a plurality of applications and generates a display signal for displaying a plurality of application screens generated by the respective applications in divided regions on the display device. The information processing device accepts a user instruction to change the allocation of the divided regions, changes the allocation of the divided regions in accordance with the user instruction, determines if the size of a first region in which an application screen having a specific aspect ratio is displayed satisfies a predetermined condition, and if it is determined that the size of the first region does not satisfy the predetermined condition, generates a floating region on the screen of the display device that is independent of the allocation of the divided regions, and displays the application screen having the specific aspect ratio in the floating region.

### CROSS REFERENCE TO RELATED APPLICATION

This patent application claims the benefit and priority of Japanese Patent Application No. 2023-144754, filed on Sep. 6, 2023, the disclosure of which is incorporated by reference herein in its entirety as part of the present application.

### FIELD

The present invention generally relates to an information processing device and a display control method.

### BACKGROUND

Conventionally, there is a technology described in Japanese Unexamined Patent Application Publication 2020-102084 (Patent Document 1) for effectively utilizing a display screen controlled by an information processing device. This publication states that “the display of a displayed object is changed more appropriately in response to dynamic size changes of a plurality of divided regions provided on a display screen.” The publication states, “[t] he display control device comprises a divided region setting unit that dynamically changes the size of a divided region provided on a screen in response to a user operation; a display control unit that provides a placement region in the divided region in which at least one display object is placed, and changes the relative positional relationship between the placement regions provided in the same divided region in response to a change in the size of the divided region; and a priority setting unit that sets relative priorities between the placement regions provided in the same divided region, and when at least a portion of the placement regions overlap due to the change in the relative positional relationship between the placement regions provided in the same divided region, the display control unit controls the display of the display object on a placement region basis on the basis of the priority set for the placement region.”

The aforementioned technology can cause the display device to display different information in each of the divided regions obtained by dividing the entire display screen, and the user can freely change the division layout. By changing the division layout, the aspect ratio of each divided region can be flexibly changed.

Any information can be displayed in each divided region, and video content including moving images and still images can also be displayed. However, when displaying video content, the aspect ratio must be maintained. Even if the aspect ratio of the divided region displaying the video changes due to a change in the division layout, the aspect ratio of the video is maintained, so there may be cases where the aspect ratio of the divided region and the aspect ratio of the video differ significantly. In this case, the reduction in the video becomes more noticeable than the reduction in the region of the divided regions, making it difficult to view the video content.

When outputting video content, there is a problem in that there are substantial limitations to changing the layout by dividing the display screen in order to ensure the visibility of the content. This problem is not limited to video content, but occurs widely when information that needs to be output in a specific aspect ratio is displayed in a divided region whose layout can be changed.

### SUMMARY

An object of the present application is to flexibly and efficiently display a variety of information on one screen.

In order to achieve the above-mentioned objective, a typical information processing device of the present application is an information processing device that is connected to a display device and a pointing device, simultaneously launches a plurality of applications, and generates display signals that display a plurality of application screens generated by each application in divided regions on the screen of the display device; where the information processing device includes: a user instruction receiving unit that receives user instructions input by a user operating the pointing device; a processing unit that executes the plurality of applications; and a display control unit that manages the divided regions and generates the display signal. The user instruction receiving unit receives a user instruction to change the allocation of the divided regions. The display control unit changes the allocation of the divided regions in accordance with the user instructions, and determines whether the size of a first region in which an application screen having a specific aspect ratio is displayed satisfies a predetermined condition. When the display control unit determines that the size of the first region does not satisfy a predetermined condition, the display control unit generates a floating region on the screen of the display device that is independent of the allocation of the divided regions, and displays an application screen having the specific aspect ratio in the floating region.

Furthermore, one typical display control method of the present application is for an information processing device connected to a display device and a pointing device, that simultaneously starts a plurality of applications, and that generates a display signal for displaying a plurality of application screens generated by the respective applications in divided regions on a screen of the display device, comprising a step of: the information processing device accepting a user instruction for changing the allocation of the divided regions by a user operation on the pointing device; changing the allocation of the divided regions in accordance with the user instruction; determining whether a size of a first region, in which an application screen having a specific aspect ratio is displayed, satisfies a predetermined condition; generating a floating region independent of the allocation of the divided region on the screen of the display device, and displaying an application screen having the specific aspect ratio of the floating region, when it is determined that the size of the first region does not satisfy a predetermined condition.

The present device and method can display a variety of information flexibly and efficiently. The following description of the embodiments will elucidate the problems, configurations, and effects other than those described above.

### BRIEF DESCRIPTION OF THE DRAWINGS

FIGS. 1A-1C are explanatory diagrams of screen display controls by an information processing device according to an embodiment;

FIGS. 2A-2F are explanatory diagrams of floating regions;

FIGS. 3A-3F are explanatory diagrams of redisplaying divided regions;

FIG. 4 is a diagram depicting the configuration of an information processing device;

FIG. 5 is a flowchart of a process for generating a floating region; and

FIG. 6 is a flowchart of a process for deleting a floating region due to overflow.

### DETAILED DESCRIPTION OF EMBODIMENTS

Next, an embodiment of the present application will be described using drawings.

### Embodiment 1

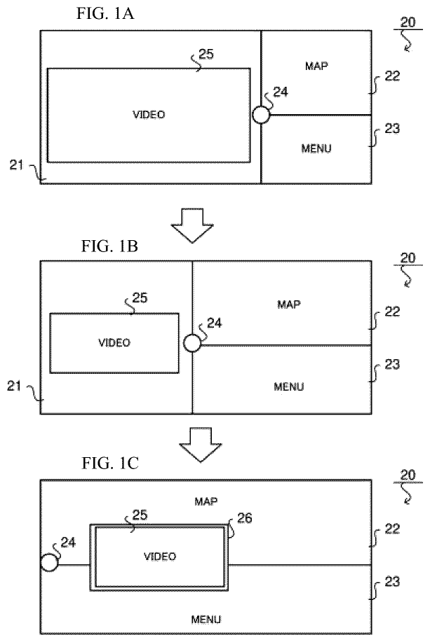

FIGS. 1A-1C are explanatory diagrams of screen display controls by an information processing device according to an embodiment. The information processing device of the embodiment is mounted on a vehicle and controls a screen 20 of a display device mounted on the vehicle.

The information processing device can divide the screen 20 and generate and manage a plurality of divided regions.

The information processing device can simultaneously run a plurality of applications.

The information processing device generates a display signal for displaying a plurality of application screens generated by a plurality of applications in a plurality of divided regions, respectively.

The plurality of applications include, but are not limited to, a map application that displays maps and provides route guidance, a video output application that outputs video content from recorded videos or television broadcasts, and a management application that manages the information processing device from a menu screen. The information processing device assigns one application to one divided region.

In the example of FIGS. 1A-1C, the screen 20 is a rectangle whose horizontal sides are longer than the vertical sides.

The information processing device divides a screen 20 into two parts, left and right, with the left part being a divided region 21.

The information processing device further divides the right side of the screen 20 that is divided into two parts, left and right, into two parts, upper and lower, with the upper side being divided region 22 and the lower side being divided region 23.

The information processing device accepts a drag operation on the slider icon 24 by the user, and changes the allocation of the divided regions 21 to 22 in accordance with the movement of the slider icon 24.

The left edge of the divided region 21 coincides with the left edge of the screen 20, the upper and lower edges coincide with the upper and lower edges of the screen 20, and the right edge is defined by the position of the slider icon 24.

The right edge of the divided region 22 coincides with the right edge of the screen 20, the upper edge coincides with the upper edge of the screen 20, and the left edge and lower edge are defined by the position of the slider icon 24.

The right edge of the divided region 23 coincides with the right edge of the screen 20, the lower edge coincides with the lower edge of the screen 20, and the left edge and upper edge are defined by the position of the slider icon 24.

The user can change the shapes of the divided regions 21 to 23 at once by changing the position of the slider icon 24 using a drag operation.

In FIG. 1A, the information processing device displays video content 25 in divided region 21, a map in divided region 22, and a menu screen in divided region 23. Of these display outputs, the aspect ratio of the video content 25 is fixed. For example, the aspect ratio of video content created for analog broadcasting is 4:3, and the aspect ratio of video content created for digital broadcasting is 16:9. For movie content, the Cinemascope size of 2.35:1 is also used. The video content 25 is displayed in divided region 21 so as to maximize the area while maintaining the aspect ratio. The change in allocation to the divided region 21 is an increase or decrease in the horizontal width, but the vertical width remains unchanged. Since the vertical width of the video content 25 is changed in accordance with the change in the horizontal width, when the size of divided region 21 is reduced, the unused regions above and below the video content 25 become larger. It should be noted that unused regions are displayed in a single color, such as black or gray.

In FIG. 1B, the information processing device accepts an operation of dragging the slider icon 24 to the left, and changes the allocation of divided regions 21 to 23. The width of divided region 21 is reduced, and the size of the video content 25 is reduced while maintaining the aspect ratio. If the width of divided region 21 is smaller than a certain size, the video content 25 will be excessively small, inhibiting visual recognition of the details of the video content 25.

As depicted in FIG. 1C, when the information processing device determines that the size of divided region 21 does not satisfy a predetermined condition, a floating region 26 is generated on the screen 20 independent of the allocation of the divided regions 21 to 23, and the video content 25 is displayed in the floating region 26. When the floating region 26 is generated, the information processing device temporarily deletes the divided region 21 that displayed the video content 25, and displays the divided regions 22 and 23 on a screen divided into two parts, upper and lower.

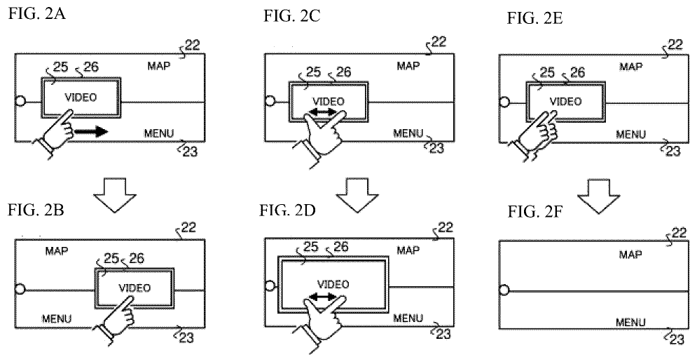

FIGS. 2A-2F are explanatory diagrams of floating regions.

When a drag operation on the floating region 26 is received (FIG. 2A), the information processing device changes the position of the floating region 26 on the screen 20 (FIG. 2B). This operation does not affect the allocation of the divided regions 22 and 23.

When a pinch-in operation or a pinch-out operation is received on the floating region 26 (FIG. 2C), the information processing device changes the size of the floating region 26 and the video content 25 while maintaining the aspect ratio (FIG. 2D). This operation does not affect the allocation of the divided regions 22 and 23.

When a double tap operation is received on the floating region 26 (FIG. 2E), the information processing device deletes the floating region 26 and the video content 25 (FIG. 2F). This operation does not affect the allocation of the divided regions 22 and 23, and the screen is maintained as being divided into upper and lower screens.

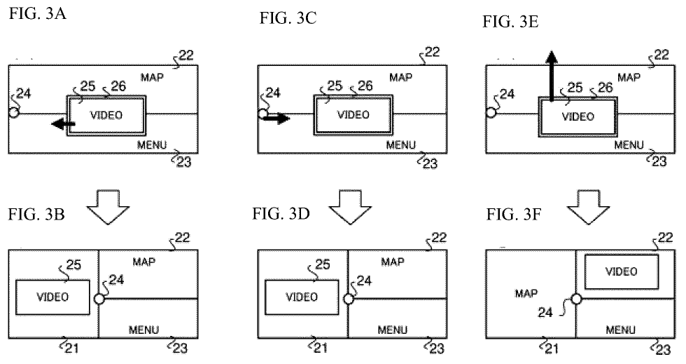

FIGS. 3A-3F are explanatory diagrams of redisplaying a divided region 21.

When a specific movement operation is received to drag the floating region 26 to a position on the left side of the screen 20 where the divided region 21 was located (FIG. 3A), the information processing device re-displays the divided region 21, displays the video content 25 in the divided region 21, and deletes the floating region 26 (FIG. 3B). At this time, the information processing device displays a map in divided region 22 and a menu screen in divided region 23.

When an operation of generating a divided region 21 using the slider icon 24 (for example, an operation of dragging the slider icon 24 to the right) is received (FIG. 3C), the information processing device re-displays the divided region 21, displays the video content 25 in the divided region 21, and deletes the floating region 26 (FIG. 3D). At this time, the information processing device displays a map in divided region 22 and a menu screen in divided region 23.

When a specific movement operation for dragging the floating region 26 to a specific position on the left side of the screen 20 is received (FIG. 3E), the information processing device determines a second region located at the position to which the floating region 26 has been moved. Here, as an example, a case where the second region is divided region 22 will be described. The information processing device displays the video content 25 that was displayed in the floating region 26 in divided region 22 and deletes the floating region 26. The information processing device re-displays divided region 21, and displays the map that was displayed in divided region 22 in divided region 22 (FIG. 3F). The divided region 23 continues to display the menu screen.

Here, a specific movement operation is, for example, a movement operation in which part of the floating region 26 extends outside the screen 20, but the information processing device may determine that a specific movement operation has occurred when the outer edge of the floating region 26 approaches or reaches the outer edge of the screen 20.

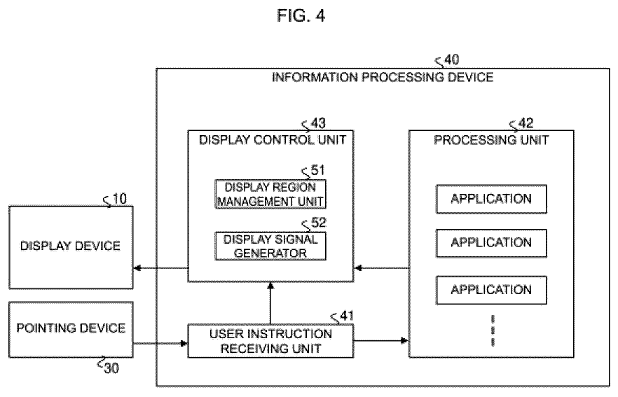

FIG. 4 is a configuration diagram of an information processing device.

The information processing device 40 is connected to the display device 10 and the pointing device 30.

The display device 10 is provided, for example, on the dashboard of a vehicle, and has a screen 20.

The pointing device 30 is a device that accepts a user operation to indicate a position on the screen 20. The pointing device 30 is, for example, a touch panel provided on the screen of the display device 10 or a touch pad installed separately from the display device 10. The pointing device 30 may be a device that identifies a pointing gesture of a user using a camera or other spatial recognition sensor to identify a position on the screen.

The information processing device 40 includes a user instruction receiving unit 41, a processing unit 42, and a display control unit 43. The functions of the user instruction receiving unit 41, the processing unit 42, and the display control unit 43 may be achieved by a CPU (Central Processing Unit) that executes corresponding programs.

The user instruction receiving unit 41 receives a user instruction provided by a user operating the pointing device 30.

The processing unit 42 executes applications corresponding to various functions of the information processing device 40. The processing unit 42 can launch and execute a plurality of applications simultaneously. The plurality of applications include a map application that displays a map and provides route guidance, a video content application that outputs video content, and a management application that manages the information processing device from a menu screen. A video content application is an application that outputs video content having a specific aspect ratio, and includes, for example, a video playback application that plays video recorded on a DVD disc or a Blu-ray (registered trademark) disc, a television broadcast receiving application that receives a television broadcast and outputs the broadcast screen, or a network video playback application that receives and plays video stored on an external server via a network. A video output application is an application that outputs video content having a particular aspect ratio. For example, the aspect ratio of video content created for analog broadcasting is 4:3, and the aspect ratio of video content created for digital broadcasting is 16:9. For movie content, the Cinemascope size of 2.35:1 is also used.

The display control unit 43 includes a display region management unit 51 and a display signal generating unit 52.

The display region management unit 51 sets and manages a display region on the screen 20. The display region management unit 51 can set one display region over the entire screen 20, or can divide the screen 20 to set a plurality of display regions (divided regions). The display region management unit 51 can also set a display region (floating region) that is superimposed on another display region and whose position and size can be changed independently of the other display regions.

The display region management unit 51 assigns one application to one display region.

The display signal generating unit 52 generates a display signal for synthesizing a plurality of application screens generated by a plurality of applications and displays each of the application screens in the assigned display region.

When the user instruction receiving unit 41 receives a user instruction to change the allocation of the divided regions, the display region management unit 51 of the display control unit 43 changes the allocation of the divided regions in accordance with the user instruction.

The display region management unit 51 determines whether the size of a first region, which is a divided region in which an application screen having a specific aspect ratio is displayed, satisfies a predetermined condition, which will be described later. If it is determined that the size of the first region does not satisfy a predetermined condition, the display region management unit 51 generates a floating region on the screen 20 independent of the allocation of the divided regions and displays an application screen having a specific aspect ratio in the floating region.

When the user instruction receiving unit 41 receives a user instruction requesting movement of the floating region, the display region management unit 51 of the display control unit 43 moves the floating region in accordance with the user instruction. When a specific movement operation is performed to bring the floating region closer to the outer edge of the screen 20, the display region management unit 51 determines a second region, which is a divided region located at the position to which the floating region has been moved. The display region management unit 51 displays the application screen that was displayed in the floating region at the second region, and deletes the floating region. A specific movement operation is, for example, a movement operation in which a portion of the floating region extends outside the screen 20. However, the information processing device may determine that a specific movement operation has occurred when the outer edge of the floating region approaches or reaches the outer edge of the screen 20, or a threshold may be set in advance and the information processing device may determine that a specific movement operation has occurred when a portion of the floating region extends outside the screen 20 by more than a threshold value. In the latter case, overflow of the floating region due to an erroneous operation by the user can be tolerated.

When an application screen that was displayed in the floating region is displayed in the second region, if another application screen is displayed in the second region, the display region management unit 51 of the display control unit 43 displays the other application screen in the first region.

The display region management unit 51 of the display control unit 43 can temporarily delete the first region from the screen 20 when displaying a floating region, and re-display the first region when displaying another application screen in the first region. The first region may also be re-displayed when the floating region is moved to a location where the first region was displayed, or when an operation requesting the display of the first region is received.

The screen 20 of the display device 10 may have any shape, but in the present embodiment, the shape is a rectangle with horizontal sides longer than the vertical sides. The arrangement of the split screens on the screen 20 can also be arbitrary, but in the present embodiment, the display region management unit 51 of the display control unit 43 divides the screen 20 of the display device 10 into two halves, left and right, uses one of the divided regions as one divided region, and further divides the other divided region of the screen 20 into two halves, upper and lower, and arranges these regions as two divided regions.

The display region management unit 51 of the display control unit 43 generates a floating region if one of the divided regions, left or right half, of the screen 20 is a first region (a divided region in which an application screen having a specific aspect ratio is displayed), on the condition that the horizontal length (width) of the region is less than or equal to a threshold value. The vertical length (height) of one of the two divided regions, left or right, of the screen 20 does not change when the allocation of the divided region is changed, so the necessity of a floating region can easily and reliably be determined on the basis of the horizontal width alone. This threshold value may vary depending on the aspect ratio of the video content. In other words, when video content with a large aspect ratio is displayed, the threshold value is increased, and when video content with a small aspect ratio is displayed, the threshold value is decreased.

If one of the divided regions obtained by dividing the screen 20 into two regions, left and right, and then further dividing one region into two regions, upper and lower, is a first region, the display region management unit 51 of the display control unit 43 uses the height and width of that region as predetermined conditions. This is because the height and width of these divided regions can be changed by changing the allocation. In this case, rather than making a determination on the basis of the height or width of the region, the aspect ratio of the first region may be compared with the aspect ratio of the video content, and a floating region may be generated if the difference or ratio between the two is equal to or exceeds a threshold value.

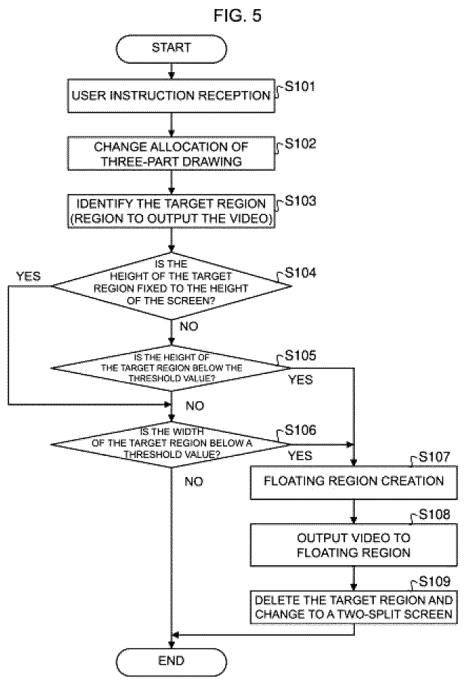

FIG. 5 is a flowchart of the process of generating a floating region. The flowchart starts with three divided regions displayed. The user instruction receiving unit 41 receives a user instruction from the pointing device 30 (step S101).

The display region management unit 51 changes the allocation of the divided regions according to the user instruction (step S102). The display region management unit 51 specifies the target region for determination (step S103). The target region for determination is a region that displays video content with a specific aspect ratio and that may require a floating region due to a change in the allocation of the divided regions. Here, the target region is the region in which the video content is displayed, or in other words, the divided region assigned to the video content application.

The display region management unit 51 determines whether the height of the target region is fixed to the height of the screen 20 (step S104). One of the two divided regions, left or right region of the screen 20, is region that is fixed by the height of the screen 20. The divided regions obtained by dividing the screen 20 into two parts, left and right, and further dividing one divided region into two parts, upper and lower, are not regions that are fixed by the height of the screen 20.

If the height of the target region is not fixed to the height of the screen 20 (step S104; No), the display region management unit 51 determines if the height of the target region is equal to or less than the height threshold (step S105). The height threshold may vary depending on the aspect ratio of the video content. In other words, when video content with a large aspect ratio is displayed, the threshold value is made small, and when video content with a small aspect ratio is displayed, the threshold value is made large.

If the height of the target region is fixed by the height of the screen 20 (step S104; Yes), or if the height of the target region is not equal to or less than the height threshold (step S105; No), the display region management unit 51 determines if the width of the target region is equal to or less than a width threshold (step S106). The width threshold may be changed depending on the aspect ratio of the video content. In other words, when video content with a large aspect ratio is displayed, the threshold value is increased, and when video content with a small aspect ratio is displayed, the threshold value is decreased.

If the width of the target region is not equal to or less than the width threshold (step S106; No), the display region management unit 51 terminates the process.

If the height of the target region is less than or equal to the height threshold (step S105; Yes), or if the width of the target region is less than or equal to the width threshold (step S106; Yes), the display region management unit 51 generates a floating region (step S107) and outputs the video that was displayed in the target region to the floating region (step S108). The display region management unit 51 deletes the target region, changes the screen to a two-split screen (step S109), and terminates the process.

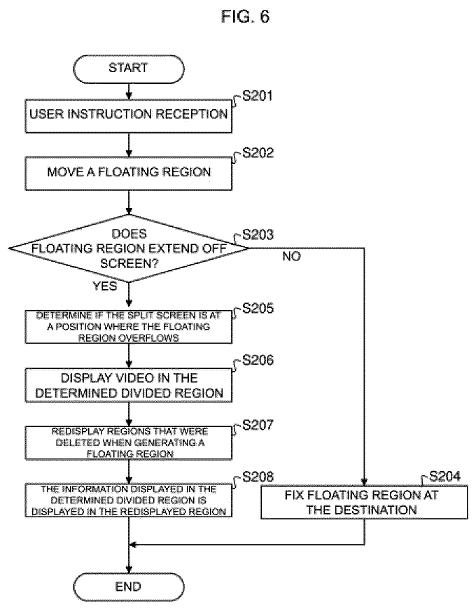

FIG. 6 is a flowchart of a process for deleting a floating region due to overflow. The flowchart begins with two divided regions, and a floating region is displayed. The user instruction receiving unit 41 receives a user instruction from the pointing device 30 (step S201).

The display region management unit 51 moves the floating region in accordance with a user instruction (step S202), and determines whether the floating region has extended beyond the edge of the screen 20 (step S203).

If the floating region does not extend past the screen 20 (step S203; No), the display region management unit 51 fixes the floating region at the destination (step S204) and terminates the process.

If the floating region extends past the screen 20 (step S203; Yes), the display region management unit 51 determines the split screen from which the floating region extends (step S205). The display region management unit 51 displays the video that was displayed in the floating region in the determined divided region (step S206). The display region management unit 51 re-displays the divided region that was temporarily deleted when the floating region was generated (step S207), displays the information that was displayed in the determined divided region in the re-displayed divided region (step S208), and terminates the process.

When the divided region, which is the first region, is re-displayed and a video is displayed therein, the size of the video is set to a preset size, and the size of the re-displayed divided region is also determined so that the video can be displayed at the preset size. The size may be set to the minimum size that can be displayed in the divided region, or in other words, a size corresponding to the vertical and horizontal thresholds of the first region.

The floating region extends from the screen 20 when the coordinates of the outer edge of the floating region are outside the screen 20. The amount of overflow required for the video to be displayed in the second region can be set arbitrarily. In other words, the video may be displayed in the second region when the outer edge of the floating region reaches the outer edge of the screen 20, or a threshold may be set in advance, and the video may be displayed in the second region when a portion of the floating region extends outside the screen 20 beyond the threshold value. In the latter case, overflow of the floating region due to an erroneous operation by the user can be tolerated. When the floating region extends beyond the plurality of divided regions, one of the divided regions is selected as the second region. For example, a divided region that overlaps with a floating region across a large area may be set as the second region. Although the condition provided in the example is that the floating region extends beyond the screen 20, the video may be displayed in the second region under other conditions, such as when the floating region comes sufficiently close to the outer edge of the screen 20. In other words, any condition may be used, so long as the condition indicates that an operation to move the floating region to the outer edge of the screen 20 has been performed.

An example of a process for determining both the height and width of a divided region obtained by dividing the screen 20 into two halves, left and right, and then further dividing the second region into two halves, upper and lower, has been described, but only the height may be determined in the divided region obtained by dividing the screen 20 into two halves, left and right, and then further dividing the second region into two halves, upper and lower. Furthermore, instead of being limited to the height and width of the divided regions, the region of the video that can be displayed in the divided regions after the allocation has been changed may be calculated to determine whether or not a floating region is required. For example, the processes of S104 to S106 may be replaced with a process of comparing the aspect ratio of the target region after the allocation change with the aspect ratio of the video content displayed therein, and generating a floating region if the difference becomes equal to or exceeds a threshold value.

As described above, the information processing device 40 is connected to a display device 10 and a pointing device 30, simultaneously starts a plurality of applications, and generates a display signal for displaying a plurality of application screens generated by the respective applications in divided regions on a screen of the display device 10. The information processing device 40 includes a user instruction receiving unit 41 that receives user instructions from a user operation on the pointing device 30, a processing unit 42 that executes the plurality of applications, and a display control unit 43 that manages the divided regions and generates the display signal. The user instruction receiving unit 41 receives a user instruction to change the allocation of the divided regions. The display control unit 43 changes the allocation of the divided regions in accordance with the user instructions, and determines whether the size of a first region in which an application screen having a specific aspect ratio is displayed satisfies a predetermined condition. When the display control unit determines that the size of the first region does not satisfy a predetermined condition, the display control unit 43 generates a floating region on the screen of the display device that is independent of the allocation of the divided regions, and displays an application screen having the specific aspect ratio in the floating region.

With this device, the allocation of divided regions can be freely changed while ensuring the visibility of applications with a fixed aspect ratio, so a variety of information can be flexibly and efficiently displayed.

The user instruction receiving unit 41 receives a user instruction requesting movement of the floating region, and the display control unit 43 moves the floating region in accordance with the user instruction. When an operation is performed to move the floating region to the outer edge of the screen of the display device, the display control unit determines a second region to which the floating region is moved, displays the application screen that was displayed in the floating region in the second region, and deletes the floating region.

When the display control unit 43 displays the application screen that was displayed in the floating region in the second region, if another application screen is displayed in the second region, the display control unit displays the other application screen in the first region.

The display control unit 43 temporarily deletes the first region from the screen of the display device when displaying the floating region, and re-displays the first region when displaying the other application screen in the first region.

With this device, the contents can be flexibly moved between the floating region and the divided region.

The screen of the display device 10 is a rectangle with horizontal sides longer than vertical sides, and the display control unit 43 divides the screen of the display device 10 into two halves, left and right, one of the halves is used as a divided region, and further divides the other of the two halves, left or right, into two further divided regions, upper and lower, and if one of the divided regions obtained by dividing the screen of the display device 10 into two halves, left or right, is the first region, the display control unit 43 uses the horizontal length of the region as the predetermined condition, and if either of the divided regions obtained by dividing the other of the two halves, left or right, into two further halves, upper and lower, is the first region, the display control unit 43 uses the vertical length of the region as the predetermined condition.

With this device, the necessity of a floating region can be efficiently determined by a determination process adapted to a three-part display.

The user operation on the pointing device 30 is a drag operation.

With this device, a floating display with good operability can be achieved by taking advantage of the characteristics of the divided display, and the degree of freedom in the layout of the divided display is improved.

Note that the present invention is not limited to the abovementioned examples and includes various modified examples. For example, while the abovementioned examples have been described in detail in order to describe the present invention in an easy-to-understand manner, the present invention is not necessarily limited to those with all the described configurations. Moreover, not only the deletion of such configurations, but also the replacement or addition of configurations is possible.

### REFERENCE NUMERALS

10. Display device, 20. Screen, 21 to 23. Divided region, 24. Slider icon, 25. Video, 26. Floating region, 30. Pointing device, 40. Information processing device, 41. User instruction receiving unit, 42. Processing unit, 43. Display control unit, 51. Display region management unit, 52. Display signal generating unit

1. An information processing device that is connected to a display device and a pointing device, that simultaneously starts a plurality of applications, and that generates a display signal for displaying a plurality of application screens generated by the respective applications in divided regions on a screen of the display device, the information processing device comprising:
a user instruction receiving unit that receives a user instruction input by a user operation using the pointing device;
a processing unit that executes the plurality of applications; and
a display control unit that manages the divided regions and generates the display signals;
wherein the user instruction receiving unit receives a user instruction to change the allocation of the divided regions; and
the display control unit changes the allocation of the divided regions in accordance with the user instruction, determines whether a size of a first region in which an application screen having a specific aspect ratio is displayed satisfies a predetermined condition, generates a floating region independent of the allocation of the divided regions on the screen of the display device, and displays an application screen having the specific aspect ratio in the floating region if the size of the first region is determined to not satisfy a predetermined condition.

2. The information processing device according to claim 1, wherein the user instruction receiving unit receives a user instruction requesting movement of the floating region; and the display control unit moves the floating region in accordance with the user instruction, determines a second region to be located at a position to which the floating region has been moved if an operation of moving the floating region to an outer edge of a screen of the display device is performed, displays the application screen that was displayed in the floating region in the second region, and deletes the floating region.

3. The information processing device according to claim 2, wherein the display control unit displays another application screen in the first region if another application screen is displayed in the second region when the application screen that was displayed in the floating region is displayed in the second region.

4. The information processing device according to claim 3, wherein the display control unit temporarily deletes the first region from the screen of the display device when displaying the floating region, and re-displays the first region when displaying the other application screen in the first region.

5. The information processing device according to claim 1, wherein the screen of the display device is a rectangle with a horizontal side that is longer than the vertical side; the display control unit uses one of the two divided regions, left or right, of the display device as one divided region and further divides the other of the two halves, left or right, into two further divided regions, upper and lower; the display control unit uses a horizontal length of the region as a predetermined condition if one of the divided regions obtained by dividing the screen of the display device into two regions, left and right, is a first region; and the display control unit uses a vertical length of the region obtained by dividing the other region of the two left or right regions of the screen of the display device if either of the divided regions further divided into upper and lower regions is the first region.

6. The information processing device according to claim 1, wherein the predetermined condition varies depending on the aspect ratio of the application screen.

7. The information processing device according to claim 1, wherein the predetermined condition is that the difference or ratio between the aspect ratio of the first region and the aspect ratio of the application screen is equal to or greater than a predetermined threshold value.

8. The information processing device according to claim 1, wherein the user operation on the pointing device is a drag operation.

9. A display control method for an information processing device connected to a display device and a pointing device that simultaneously starts a plurality of applications and that generates a display signal for displaying a plurality of application screens generated by the respective applications in divided regions on a screen of the display device, the display control method comprising the steps of:
accepting a user instruction for changing the allocation of the divided regions by a user operation on the pointing device;
changing the allocation of the divided regions in accordance with the user instruction;
determining whether a size of a first region, in which an application screen having a specific aspect ratio is displayed, satisfies a predetermined condition; and
generating a floating region independent of the allocation of the divided region on the screen of the display device, and displaying an application screen having the specific aspect ratio of the floating region when it is determined that the size of the first region does not satisfy a predetermined condition.
